(19) United States
(12) Patent Application Publication
(10) Pub. No.: US 2022/0400670 A1
(43) Pub. Date: Dec. 22, 2022

(54) PROTOPANAXATRIOL (PPT)-TYPE COMPOUNDS AS ACTIVE INGREDIENTS IN INSECTICIDE PRODUCTS

(71) Applicant: STOCKTON (ISRAEL) LTD., Petach Tikva (IL)

(72) Inventor: Alon GLICK, Mazkeret Batya (IL)

(21) Appl. No.: 17/765,196

(22) PCT Filed: Sep. 29, 2020
(86) PCT No.: PCT/IL2020/051058

§ 371 Date: Mar. 30, 2022

(30) Foreign Application Priority Data
Oct. 3, 2019 (IL) 269795

(51) Int. Cl. A01N 31/16; A01N 43/40; A01N 47/40; A01N 65/26; A01P 7/04

(52) U.S. Cl. CPC A01N 31/16; A01N 43/40; A01N 47/40; A01N 65/26; A01P 7/04

(57) ABSTRACT

The present invention relates to protopanaxatriol (PPT)-type compounds and compositions comprising thereof useful for controlling insect infestations on plants. The present invention also relates to methods for treating, controlling and/or preventing insect infestation on a plant comprising applying a protopanaxatriol-type compound or a composition comprising thereof onto the plant or a part of the plant.

### FIELD OF THE INVENTION

The present invention relates to compositions comprising protopanaxatriol (PPT)-type compounds, having inhibitory biological activities in insects. The compositions of the invention, comprising compounds of the protopanaxatriol family, as the sole active ingredient, or in combination with other pesticides, are useful insecticides.

The present invention also relates to methods for controlling insects by applying the abovementioned compositions comprising protopanaxatriol-type compounds to the insects and/or plants, either by topical application, e.g. by spraying the environment, the plants or the insects themselves, or by watering the plants with water containing said compositions.

### BACKGROUND OF THE INVENTION

Insect infestations in plants cause extensive damage directly by feeding on the plants, as well as indirectly, by reducing quality of the produce, secreting destructive materials (such as honeydew) and transmitting economically important viruses and other plant diseases. Currently available management programs of insect infestations mainly rely on chemical agents used as insecticides. However, the continuous use of these chemicals may result in environment and soil contamination, and insects developing resistance to the chemical compounds themselves, as well as to similar compounds from the same class.

Ginsenosides, a group of triterpenoid saponins, are the main pharmacological constituents of ginseng. The major components of ginsenosides are reported as dammarane-type ginsenosides, which are divided into two groups according to their aglycone structure: protopanaxadiol (PPD) and protopanaxatriol (PPT). PPT and other ginsenosides are currently being investigated for their use in medicine and involvement in a wide range of pathologies. So far, ginsenosides were found to have various anti-cancer, anti-diabetes, anti-fatigue, anti-aging, hepatoprotective, and neuroprotective effects.

It is an object of the present invention to provide natural, environment friendly, non-toxic compositions for controlling insect infestations on plants.

It is a further object of the invention to provide insecticide compositions comprising protopanaxatriol (PPT)-type compounds for treating, controlling and/or preventing insect infestation on plants.

It is an object of the present invention to provide a method for treating, controlling and/or preventing insect infestation on plants.

Other objects and advantages of the invention will become apparent as the description proceeds.

### SUMMARY OF THE INVENTION

In one aspect, the present invention provides a composition comprising at least one protopanaxatriol (PPT)-type compound, which is an insecticide composition, for treating, controlling and/or preventing insect infestation on plants.

According to one embodiment of the invention, the PPT-type compound is selected from PPT-, Rg₁-, Rg₂-, Re-, Rf-, Rh₁- and F1-ginsenoside or any derivative or configuration or modification thereof. In a specific embodiment, the PPT-type compound is PPT.

In some embodiments of the invention, the insect is a sucking insect or a chewing insect.

In one embodiment, the insect is resistant to one or more insecticides.

In some embodiments of the invention, the at least one PPT-type compound is applied in combination with one or more additional active ingredient and/or an adjuvant, carrier or diluent. According to one embodiment, the additional active ingredient is selected from an insecticide, a neonicotinoid compound, vegetable oil, mineral oil, a terpene, spirotetramat, spinetoram, spionosad, anthranilic diamide, keto-enol, benzoylurea, an insect growth regulator (IGR, such as pyriproxyfen), pyrrol and diafenthiuron, or any combination thereof. In specific embodiments, the neonicotinoid compound is acetamiprid and the vegetable oil is neem oil.

According to one embodiment of the invention, the protopanaxatriol (PPT)-type compound and the additional active ingredient are applied separately, simultaneously or sequentially.

In another aspect, the present invention provides a composition comprising protopanaxatriol (PPT)-type compound for use as an insecticide, in the treatment, control and/or prevention of insect infestation on plants.

Another aspect of the invention provides the use of protopanaxatriol (PPT)-type compound in the preparation of an insecticide or an insect control agent.

A further aspect of the invention provides the use of protopanaxatriol (PPT)-type compound in combination with one or more additional active ingredient, in the preparation of an insecticide or an insect control composition.

In yet a further aspect, the present invention provides a method for treating, controlling and/or preventing insect infestation on a plant comprising applying at least one protopanaxatriol (PPT)-type compound, or a composition comprising thereof, onto a plant or a part of a plant.

According to some embodiments of the invention, the PPT-type compound or a composition comprising thereof is applied to the plant by spraying, dipping, watering, drenching, irrigating, evaporating, dusting, fogging, foaming, spreading-on, or injecting.

In one embodiment, the PPT-type compound or a composition comprising thereof is applied to the plant by foliar application.

In some embodiment of the invention, the at least one PPT-type compound is applied in combination with one or more additional active ingredient and/or an adjuvant, carrier or diluent. According to one embodiment, the protopanaxatriol (PPT)-type compound and the additional active ingredient are applied separately, simultaneously or sequentially.

Unless otherwise stated, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In addition, the materials, methods, and examples are illustrative only and are not intended to be necessarily limiting.

### BRIEF DESCRIPTION OF THE DRAWINGS

The above and other characteristics and advantages of the invention will be more readily apparent through the following examples, and with reference to the appended drawings, wherein:

FIGS. 1A-1B show the number of total Thrips tabaci (adults and larva) on cucumber leaves after treatment with protopanaxatriol (PPT).

FIG. 1A shows the number (#) of total Thrips per leaf of cucumber at 4 and 9 days post first application (DPA) of neem oil 1% (NO), Spinetoram 50 g/ha (Sp)+neem oil 1% and PPT 225 g/ha+neem oil 1% compared to untreated control (UTC) leaves.

FIG. 1B shows the number (#) of total Thrips per leaf of cucumber at day 0 and 4 DPA of PPT 225 g/ha, PPT 500 g/ha, PPT 225 g/ha+neem oil 1% (NO), Spinetoram 50 g/ha (Sp)+neem oil 1% and neem oil 1% alone compared to untreated control (UTC) leaves.

FIG. 2 shows the number (#) of total Thrips (adults and larva) per leaf of cauliflower at 7 and 14 days post first application of protopanaxatriol (PPT) at 400 g/ha or diafenthiuron (Di) at 375 g/ha, compared to untreated control (UTC).

FIGS. 3A-3B show the effect of acetamiprid and/or PPT on nymph mortality of silverleaf whitefly (SLW) biotypes B and Q in cotton plants.

FIG. 3A shows mortality level (determined as percent of pupation) of SLW biotype B nymphs in acetamiprid (Ac)-treated cotton plants or untreated controls (UTC).

FIG. 3B shows mortality level (determined as percent of pupation) of SLW biotype Q nymphs in acetamiprid (Ac)-treated cotton plants at a concentration of 10 ppm, PPT-treated cotton plants at concentrations 0.075% (0.5×), or 0.15% (1×) or untreated controls (UTC).

FIGS. 4A-4C show the effect of PPT and mineral oil (EOS) with or without spinosad (Sd) on Thrips (Thrips tabaci) and Aphids (Aphis gossypii) infestations in cotton plants. FIG. 4A shows the total number of Thrips per a cotton plant, comprising the number of Thrips adults and larva, at 6 days post the third application of Eco Oil Spray® 1% (EOS), spinosad 60.5 g/ha (Sd) and PPT 100 or 300 g/ha, as indicated compared to untreated control (UTC) plants.

FIG. 4B shows the total number of Aphids per a cotton plant, at 6 days post the third application of Eco Oil Spray® 1% (EOS), spinosad 60.5 g/ha (Sd) and PPT 100 or 300 g/ha, as indicated compared to untreated control (UTC) plants.

FIG. 4C shows the level in arbitrary units (AU) of the damage to the plant on a scale of 0-5 and the vigor of the plant on a scale of 0-10.

### DETAILED DESCRIPTION OF THE INVENTION

The disclosed invention provides compositions useful for controlling insect infestations on plants. The compositions are specifically useful in preventing and controlling plant damage caused by sap-sucking and chewing insects.

The compositions of the invention comprise the ginsenoside compounds of the protopanaxatriol (PPT)-type group, having the general chemical structure of:

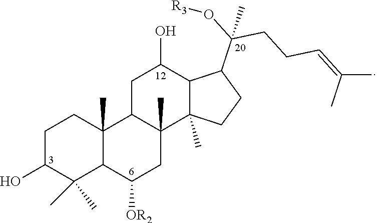

Accordingly, the compounds of the invention include the ginsenosides PPT, Rg₁, Rg₂, Re, Rf, Rh₁ and F1, having R₂ and R₃ substituents as defined in Table 1. The compounds of the invention also include any derivative or configuration or modification of the compounds listed in Table 1, such as compounds further glycosylated, further carrying other sugar moieties, and/or carrying any carbohydrate modification.

TABLE 1
R₂ and R₃ substituents of PPT-type compounds

| PPT-type compound | R₂ | R₃ |
|---|---|---|
| PPT | H | H |
| Rg₁ | Glucose | Glucose |
| Rg₂ | Glucose(2-1)rhamnose | H |
| Re | Glucose(2-1)rhamnose | Glucose |
| Rf | Glucose(2-1)glucose | H |
| Rh₁ | Glucose | H |
| F1 | H | Glucose |

PPT-type compounds can be extracted and isolated from ginseng plants using routine methods well-known in the art, such as high performance liquid chromatography (H PLC), gas chromatography (GC) or electrophoresis. Alternatively, PPT-type compounds can be synthesized in plants other than ginseng by utilizing known metabolic engineering techniques. In a non-limiting example, PPT can be biosynthesized in tobacco plants by artificial deglycosylation of 2,3-oxidosqualene by expressing the required enzymes in the tobacco plant: (1) Panax ginseng damarenediol-II synthase (PgDDS) that converts 2,3-oxidosqualene to damarenediol-II (DD); (2) CYP716A47 that catalyzes hydroxylation of damarenediol-II to produce protopanaxadiol (PPD); and (3) CYP716A53v2 that catalyzed hydroxylation of PPD into PPT.

It has now been found that PPT-type compounds are capable of controlling a wide range of insect populations that feed on plants. The compositions according to the invention thus efficiently serve as natural, environment friendly, non-toxic insecticides, either before or after the plant has encountered the insect.

The term “controlling insect infestations on plants” as used herein relates to a reduction in insect incidence at all stages of growth, including egg, larva, nymph, instar and adult. The term also encompasses the reduction in the severity of damage to the treated plant. It should be noted that the direct insecticidal effect of PPT is manifested on the early stages of the insect's life cycle, specifically the egg, larval and instar stages, resulting in an overall reduction in the insect population at all stages.

It has also been found that the addition of at least one PPT-type compound to acceptable insecticides treatments, including neem oil, acetamiprid, spirotetramat, spinetoram, spionosad, parafinic medium-heavy white mineral oil, and diafenthiuron greatly improved the efficacy of the treatments against damaging insects.

The insecticide compositions according to the invention, comprising at least one PPT-type compound, or at least one PPT-type compound in combination with other active ingredients, have demonstrated significant beneficial effects with respect to plant health and vigor.

As can be appreciated by a person skilled in the art, the pesticide activity of some of the known synthetic compounds, such as spirotetramat and diafenthiuron, at some concentrations that are suitable for use in pest control in crop plants may be enhanced compared the activity of the PPT-type compounds. However, use of PPT-type compounds may be advantageous since these compounds are not only naturally-existing and non-toxic compounds, but are also known to have beneficial therapeutic effects. Thus, traces of the PPT-type compounds in edible parts of the plants are not expected to have detrimental effects as traces of synthetic insecticides. In addition, being natural compounds, members of the PPT family may be used as insecticides in organic crop products. Furthermore, not only does the combination of PPT-type compounds with other active materials enhance the insecticide activity of the material, the addition of PPT-type compounds to other synthetic insecticides enables the reduction of the concentration of the synthetic compound, while maintaining similar insecticide activity, thereby reducing the amount of traces of the synthetic compound in edible parts of the plant.

Moreover, the compounds of the invention can be used as a tool for resistance management, as they are active against insects, including species (such as whiteflies) that have developed resistance to one or more acceptable insecticides, for example, insecticides of the neonicotinoids group.

Examples of pest species which may be controlled by PPT compositions include: Bemisia tabaci (silverleaf whitefly), Spodoptera littoralis (cotton leafworm), Spodoptera frugiperda (fall armyworm), Thrips tabaci (Thrips), Pectinophora gossypiella (Pink Bollworm), Aphis gossypii (aphid), Heliothis armigera (also known as Helicoverpa armigera, Cotton Bollworm), Trialeurodes spp. (white flies), Myzus persicae (aphid), Aphis fabae (aphid), Lygus spp. (capsids), Dysdercus spp. (capsids), Nilaparvata lugens (planthopper), Nephotettixc incticeps (leafhopper), Nezara spp. (stinkbugs), Euschistus spp. (stinkbugs), Leptocorisa spp. (stinkbugs), Frankliniella occidentalis (thrip), Thrips spp. (thrips), Leptinotarsa decemlineata (Colorado potato beetle), Anthonomus grandis (boll weevil), Aonidiella spp. (scale insects), Ostrinia nubilalis (European corn borer), Heliothis virescens (tobacco budworm), Helicoverpa armigera (cotton bollworm), Helicoverpa zea (cotton bollworm), Sylepta derogata (cotton leaf roller), Pieris brassicae (white butterfly), Plutella xylostella (diamond back moth), Agrotis spp. (cutworms), Chilo suppressalis (rice stem borer), Locusta migratoria (locust), Chortiocetes terminifera (locust), Diabrotica spp. (rootworms), Meloidogyne spp. (root knot nematodes), Globodera spp. and Heterodera spp. (cyst nematodes), Pratylenchus spp. (lesion nematodes), Rhodopholus spp. (banana burrowing nematodes), Tylenchulus spp. (citrus nematodes), Ceratitis capitata (Mediterranean fruit fly), Maladera insanabilis (Khomeini Beetle), Tuta absoluta (tomato leafminer).

Also encompassed by the present invention are insects which have been rendered resistant to known insecticides, for example Mospilan®, which comprises the active agent Acetamiprid (Ac).

In another aspect, the invention provides a method of treating, controlling and/or preventing insect infestation, which comprises applying an insecticidal effective amount of at least one PPT-type compound, or a composition containing one or more PPT-type compounds, optionally in combination with one or more pesticide, to an insect, a habitat of the insects, a plant infected with insects, a plant liable to infestation by the insects, or to a plant susceptible to attack by an insect.

All plants and plant parts can be treated in accordance with the invention. Plants that are encompassed by the present invention include wild plants or crop plants, for example cotton, cucumbers, cauliflower, tomatoes, peppers, melons, carrots, water melons, onions, lettuce, spinach, leeks, beans, cabbage, and other vegetable species, maize, soybeans, peanuts, potatoes, sugar beet, sugar cane, banana, cereals (wheat, rice, triticale, barley, rye, oats), tobacco, and also fruit plants, such as citrus fruits, grapes, coffee, stone fruits, apples, mango, avocado, almond, pecan and pears.

Crop plants may be plants which can be obtained by conventional breeding and optimization methods or by biotechnological and genetic engineering methods or combinations of these methods.

The term “plant” as used herein includes all development stages such as seed, seedlings, young plants, and mature plants. The term “plant part” as used herein refers to any organ or part of the plant, above and below ground, such as shoot, leaf, flower and root, for example leaves, needles, stalks, stems, flowers, fruit bodies, fruits and seeds, and also roots, tubers and rhizomes.

According to the invention, the treatment of the plants and parts of plants with PPT-type compounds, compositions and combinations thereof is effected by any of the known means of applying pesticidal compounds. For example, it may be applied, formulated or unformulated, to the insects or to a habitat of the insects, or a growing plant liable to infestation by the insects or to any part of the plant, including the foliage, stems, branches or roots, to the seed before it is planted or to other media in which plants are growing or are to be planted (such as the soil, water or hydroponic culture systems).

The PPT-type compounds, compositions and combinations may be applied directly or indirectly by spraying, dipping, watering, drenching, irrigating, drip irrigating, evaporating, dusting, fogging, foaming, spreading-on, or injecting. It is furthermore possible to apply the compounds through distribution or incorporation of a composition (such as a granular composition or a composition packed in a water-soluble bag) in soil or an aqueous environment. The PPT-type compounds, compositions and combinations may also be sprayed onto vegetation using electrodynamic spraying techniques or other low volume methods, or applied by land or aerial irrigation systems. According to a specific embodiment of the invention, direct treatment of the plants is foliar application, meaning that the PPT-type compound is applied to the foliage.

Treatment frequency with PPT-type compounds and the application rate should be adjusted according to plant to be treated and according to the level of infestation with the pest.

In order to apply a compound of the PPT family as an insecticide, to an insect, or to a plant susceptible to attack by an insect, the compound is usually formulated into a composition which includes, in addition to the PPT-type compound, a suitable inert diluent or carrier and, optionally, a surface active agent (SFA), and/or an emulsifier, and/or an oil. It is preferred that all compositions (both solid and liquid formulations) comprise, by weight, 0.0001 to 95%, more preferably 1 to 85%, for example 5 to 40%, of the PPT-type compound. The composition is generally used for the control of insects such that the PPT-type compound is applied at an amount of from 1 g to 1 kg per hectare, specifically from 50 g to 600 g per hectare, more specifically from 200 g to 500 g per hectare, even more specifically 100 g per hectare.

In a specific embodiment of the invention, the PPT-type compound is PPT having the chemical structure:

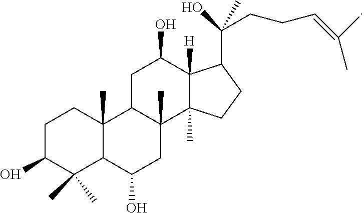

According to a specific embodiment, the PPT is the stereoisomer 20-S-PPT.

In another aspect the present invention provides an insecticidal composition comprising an insecticidal effective amount of a compound of the PPT group and a suitable carrier or diluent therefor.

It should be noted that the active agent of the PPT family can be used either as a single insect control agent or can be used in any combination thereof in the preparation of insect control compositions. Notably, the compositions of the invention can be applied to different agricultural crops in order to treat various insect pests.

The compositions of the invention comprising at least one PPT-type compound may further comprise other compounds having biological activity, for example compounds having insecticidal, fungicidal, herbicidal, nematicidal or acaricidal activity, or compounds which possess plant growth regulating activity.

Accordingly, at least one PPT-type compound may be the sole active ingredient of the composition, or it may be admixed with one or more additional active ingredients such as a pesticide, insecticide, fungicide, herbicide, or plant growth regulator.

When the PPT-type compound is applied in combination with an additional biologically active ingredient, they may be administered separately e.g. as separate compositions. In this case, the biologically active ingredients may be administered simultaneously or sequentially. Alternatively, the biologically active ingredients may be components of one composition.

The compounds of the invention may further be used with adjuvants which improve action, such as penetrants, e.g. vegetable oils (for example, neem oil, pine oil and cedar wood oil); or mineral oil (for example, Eco Oil Spray®, organic JMS Stylet-Oil®).

Examples of suitable pesticides include the following: neonicotinoid compounds, such as acetamiprid; vegetable oils, such as neem oil; mineral oils, such as paraffinic medium-heavy white mineral oil (Eco Oil Spray®, EOS), terpenes, such as linalool and limonene; spirotetramat; spinetoram; spionosad; anthranilic diamides; keto-enols; benzoylureas; insect growth regulators (IGRs); pyrroles and diafenthiuron.

The invention will now be described with reference to specific examples and materials. The following examples are representative of techniques employed by the inventors in carrying out aspects of the present invention. It should be appreciated that while these techniques are exemplary of specific embodiments for the practice of the invention, those of skill in the art, in light of the present disclosure, will recognize that numerous modifications can be made without departing from the spirit and intended scope of the invention.

### EXAMPLES

### Materials and Methods

### Materials

Acetamiprid (Ac), a neonicotinoid applied in the form of Mospilan®, which contains 200 g/L acetamiprid;

Diafenthiuron (Di), applied in the form of Pegasus 250, which contains 250 g/L diafenthiuron;

Mineral oil, applied in the form of Eco Oil Spray® (WS), which contains 99% paraffinic medium-heavy white mineral oil;

Neem oil (NO), applied in the form of NeemGuard®, which is a formulation containing 97% extraction from neem (Azadirachta indica) seed kernels (hydrophobic phase); Protopanaxatriol (PPT), having the chemical structure of:

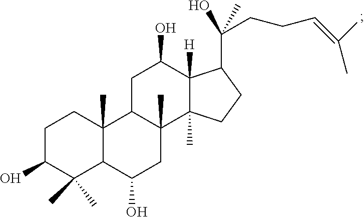

Spinetoram (Sp), applied in the form of Sparta Super™, which contains 60 g/L spinetoram;

Spionosad (Sd), a mixture of spinosyns A and D at a ratio ranging between 50:50 to 95:5, applied in the form of Tracer® or Blackhawk® which are formulations containing 44.03% or 36% w/w spinosad, respectively;

Spirotetramat (Spt), applied in the form of Movento®, which contains 100 g/L spirotetramat;

Untreated controls (UTC) were kept under the same conditions as the treated plants.

### Field Tests in Cucumber

Cucumber plants of kingstar variety at 170-190 cm height were sprayed twice at a 4 days interval with the indicted materials at a volume of 400-600 liter per hectare, using 3-nozzled ECHO backpack sprayer. The experiment included 4 repeats in random blocks of cucumber plants growth, each repeat at an area of 10-16 m². Plots having high levels of Thrips tabaci (Thrips) infestation (5-10 Thrips per leaf) at uniform distribution at the beginning of the experiment were chosen for analysis, and 10 leaves at shoulder height were picked and the number of Thrips was determined for each leaf.

### Field Tests in Cauliflower

Cauliflower plants of White Corona variety at 20-30 cm height were sprayed twice at a 7 days interval with the indicted materials at a volume of 400-500 liter per hectare, using 3-nozzled ECHO backpack sprayer. The experiment included 4 repeats in random blocks of cucumber plants growth, each repeat at an area of 20 m². plots having high levels of Thrips tabaci (Thrips) infestation (5-10 Thrips per leaf) at uniform distribution at the beginning of the experiment were chosen for analysis, and 10 leaves per plot were picked and assessed for Thrips number. The number of Thrips adults or larva on each leaf was counted using OptiVISOR® magnifying device. The number of silverleaf whitefly (SLW) nymphs on each leaf was also counted using OptiVISOR® magnifying device.

### Field Tests in Cotton

Cotton plants were sprayed 3-4 times at 6-7 days interval with the indicated materials at a volume of 400 liter per hectare. The experiment included 4-5 repeats in random blocks of cotton plants growth, each repeat at an area of 8-10 m². The number of Thrips adults or larva, as well as the number of Aphids (Aphis gossypii), on each leaf was counted using OptiVISOR® magnifying device.

Lab Tests in Cotton—Silverleaf Whitefly (Bemisia tabaci)

Cotton plants were grown in pots and sprayed with the indicated materials using a hand-sprayer. 20-25 females of Silverleaf whitefly biotype B (neonicotinoid-sensitive strain) or biotype Q (neonicotinoid-resistant strain) were transferred to each pot and attached to the treated leaves. Nymphs mortality was evaluated 1 and 2 weeks after treatment application and determined by percent (%) of pupation.

Lab Tests on Pink Bollworm (Pectinophora gossypiella)

Paper cuttings with Egg clusters of pink bollworm were soaked in a 0.15% PPT solution, and hatching and larva development were observed compared to untreated controls (UTC).

### Evaluation of Sooty Mold

At the end of the experiment the level of sooty mold covering the leaves was assessed on a scale of 0-5, where 0 equals no sooty mold and 5 equals black leaves.

### Evaluation of Thrips-Induced Damage

At the end of the experiment the damage to the upper side of leaves caused by Thrips infestation was assessed on a scale of 0-5, where 0 equals no damage and 5 equals scraping on the leaf's blade (surface).

### Evaluation of Plant's Vigor

Plant vigor was assessed using a bio-scale of 1-10, where “10” indicates a well-developed plant with a functioning apical meristem and intact young leaves emerging, and “1” indicates a stunted and underdeveloped plant with defected young leaves.

### Screening Assay for Lethality

Spodoptera littoralis stage 2-3 larva were grown in entomology trays on artificial medium. Treatment with PPT was effected by the addition of PPT (50 ppm) to the medium and lethality was assessed. The screening assay was repeated 3 times, with 4 larva replicates in each screen.

### Statistical Analysis

Statistical analysis was carried out using JMP software. Tukey-Kramer post-hoc test was used to determine the statistical significance of differences between treatment groups, with p<0.05 considered statistically significant.

### Example 1

PPT Reduces Thrips tabaci Infestation on Cucumber Plants

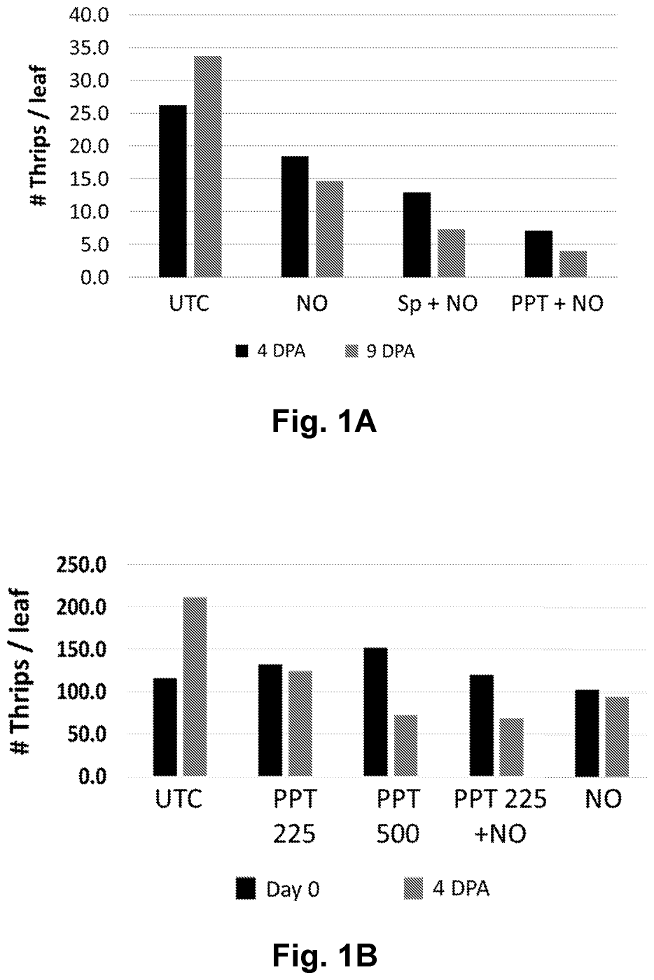

Tables 2A and 2B, as well as FIG. 1A, show the number of Thrips on leaves from cucumber plants as counted 4 and 9 days post first application (DPA). As shown in Table 2A and FIG. 1A, PPT in combination with neem oil markedly reduced the number of Thrips compared to neem oil treatment alone or untreated controls (UTC). As indicated in Table 2B the combination of PPT (225 g/ha) with neem oil 1% was found to be the most effective in this specific experiment.

TABLE 2A
Number of Thrips adults and larva on 10 cucumber
leaves at 4 and 9 DPA.

| | 4 DPA | | | 9 DPA | | |
|---|---|---|---|---|---|---|
| | Thrips | Thrips | | Thrips | Thrips | |
| | larva | adults | | larva | adults | |
| | per 10 | per 10 | | per 10 | per 10 | |
| Treatment | leaves | leaves | Total | leaves | leaves | Total |
| UTC | 157.5 | 104.8 | 262.3 | 174.5 | 162.5 | 337 |
| Neem oil 1% | 126.3 | 58.3 | 184.5 | 106.75 | 40 | 146.75 |
| Spinetoram | 82.5 | 47.3 | 129.8 | 57.75 | 15.5 | 73.25 |
| 50 g/ha + | | | | | | |
| neem oil 1% | | | | | | |
| PPT 225 g/ha + | 57.3 | 14.0 | 71.3 | 28 | 11.75 | 39.75 |
| neem oil 1% | | | | | | |

TABLE 2B
% efficacy on Thrips in cucumber leaves at 4 and 9 DPA.

% Efficacy

| Treatment | 4 DPA | 9 DPA |
|---|---|---|
| UTC | 0 | 0 |
| Neem oil 1% | 30 | 57 |
| Spinetoram 50 g/ha + neem oil 1% | 50 | 78 |
| PPT 225 g/ha + neem oil 1% | 73 | 88 |

In a second experiment, the number of Thrips adults and larva were counted on 10 leaves showing Thrips-induced damage at day 0 and 4 and 9 DPA. Tables 2C-2F and FIG. 1B show that treatment of cucumber leaves infested by Thrips with PPT sprayed at a concentration of 225 g/ha even without addition of neem oil has prevented the development and proliferation of the Thrips population compared to untreated control mainly through the reduction of Thrips larva. Doubling PPT concentration improved the efficacy of PPT and significantly reduced the number of Thrips on the leaves. In particular, PPT at 500 g/ha was significantly effective against Thrips larva infestation in cucumber leaves. Furthermore, combination of PPT at 225 g/ha with neem oil 1% showed similar efficacy as PPT alone at 500 g/ha.

TABLE 2C
Number of Thrips adults on 10 cucumber
leaves at day 0 and 4 and 9 DPA.

| Treatment | Day 0 | 4 DPA | 9 DPA |
|---|---|---|---|
| UTC | 37.8 | 89.8 | 32.3 |
| Neem oil 1% | 29.8 | 44.8 | 24.0 |
| PPT 225 g/ha | 36.0 | 78.3 | 22.3 |
| PPT 500 g/ha | 41.8 | 42.5 | 18.0 |
| PPT 225 g/ha + neem oil 1% | 37.3 | 22.5 | 11.5 |

TABLE 2D
Number of Thrips larva on 10 cucumber
leaves at day 0 and 4 and 9 DPA.

| Treatment | Day 0 | 4 DPA | 9 DPA |
|---|---|---|---|
| UTC | 78.3 | 122.0 | 43.3 |
| Neem oil 1% | 73.3 | 49.8^{a} | 18.3 |
| PPT 225 g/ha | 95.8 | 45.8^{a} | 38.8 |
| PPT 500 g/ha | 110.0 | 30.0^{a} | 13.0 |
| PPT 225 g/ha + neem oil 1% | 82.5 | 45.5^{a} | 9.5 |

^{a}p < 0.05 compared to UTC of the same day.

TABLE 2E
Number of total Thrips (adults and larva) on
10 cucumber leaves at day 0 and 4 and 9 DPA.

| Treatment | Day 0 | 4 DPA | 9 DPA |
|---|---|---|---|
| UTC | 116.0 | 211.8 | 75.5 |
| Neem oil 1% | 103.0 | 94.5^{a} | 42.3 |
| PPT 225 g/ha | 131.8 | 124.0 | 61.0 |
| PPT 500 g/ha | 151.8 | 72.5^{a} | 31.0 |
| PPT 225 g/ha + neem oil 1% | 119.8 | 68.0^{a} | 21.0^{a} |

^{a}p < 0.05 compared to UTC of the same day.

TABLE 2F
% efficacy on Thrips in cucumber leaves at 4 DPA.

| Treatment | % Efficacy |
|---|---|
| UTC | 0 |
| Neem oil 1% | 55.4 |
| PPT 225 g/ha | 41.4 |
| PPT 500 g/ha | 65.8 |
| PPT 225 g/ha + neem oil 1% | 67.9 |

### Example 2

PPT Reduces Bemisia tabaci (Silverleaf Whitefly, SLW) Infestation in Cauliflower Plants

Table 3A shows the number of SLW nymphs on leaves from cauliflower plants as counted at day 0, as well as 7 and 14 days post first application (DPA) and level of sooty mold covering the leaves. As shown in Table 3A, treatment of PPT in combination with neem oil significantly reduced the number SLW nymphs in infested cauliflower leaves compared to untreated controls (UTC). Particularly, the combination of PPT and neem oil was more effective in reducing the number of SLW nymphs on the leaves compared to neem oil treatment alone. The PPT and neem oil combination treatment also slightly reduce the levels of sooty mold covering the leaves. Moreover, the combined treatment of PPT, neem oil and acetamiprid markedly reduced the number of SLW nymphs compared to acetamiprid and neem oil treatment (without PPT). Furthermore, PPT sprayed together with neem oil and spirotetramat tended to improve the efficacy of the treatment on nymphs of SLW compared to spirotetramat and neem oil treatment (without PPT). As indicated in Table 3B, an addition of PPT to all treatments tested (neem oil; acetamiprid with neem oil; and spirotetramat with neem oil) greatly improved the efficacy of the treatments against SLW nymphs in cauliflower.

TABLE 3A
Number of SLW nymphs and levels of sooty mold on cauliflower leaves.

| | Number of SLW nymphs | | | Sooty |
|---|---|---|---|---|
| | per 1 leaf | | | mold (0-5) |
| Treatment | Day 0 | 7 DPA | 14 DPA | 14 DPA |
| UTC | 22.5 | 47.7 | 83.1 | 1.9 |
| Neem oil 1% | 21.0 | 35.3^{a} | 46.0^{a} | 0.9 |
| PPT 225 g/ha + neem oil 1% | 25.0 | 25.6^{a} | 29.3^{a,b} | 0.6 |
| Acetamiprid 60 g/ha + neem oil 1% | 27.0 | 27.9^{a} | 41.0^{a} | 0.6 |
| PPT 225 g/ha + acetamiprid 60 g/ha + | 1.5 | 24.7^{a} | 16.0^{a,b,c} | 0.6 |
| neem oil 1% | | | | |
| Spirotetramat 50 g/ha + neem oil 1% | 23.5 | 25.0^{a} | 28.6^{a} | 0.5 |
| PPT 225 g/ha + spirotetramat 50 g/ha + | 19.5 | 14.8^{a,b} | 16.3^{a,b} | 0.5 |
| neem oil 1% | | | | |

^{a}p < 0.05 compared to UTC of the same day.
^{b}p < 0.05 compared to neem oil treatment alone of the same day.
^{c}p < 0.05 compared to acetamiprid + neem oil treatment of the same day.

TABLE 3B
% efficacy on SLW nymphs in cauliflower leaves.

| | % Efficacy | |
|---|---|---|
| Treatment | 7 DPA | 14 DPA |
| UTC | 0 | 0 |
| Neem oil 1% | 26 | 45 |
| PPT 225 g/ha + neem oil 1% | 46 | 65 |
| Acetamiprid 60 g/ha + neem oil 1% | 41 | 51 |
| PPT 225 g/ha + acetamiprid 60 g/ha + neem oil 1% | 48 | 81 |
| Spirotetramat 50 g/ha + neem oil 1% | 48 | 66 |
| PPT 225 g/ha + spirotetramat 50 g/ha + neem oil 1% | 69 | 80 |

### Example 3

PPT Reduces Thrips tabaci Infestation in Cauliflower Plants

Table 4A shows the number of Thrips larva on leaves from cauliflower plants as counted 7 and 14 days post first application (DPA), as well as the assessment of the damage caused by Thrips infestation, determined by the level of scraping of the leaves blade (surface). It should be noted that prior to the application of the different treatments listed in Table 4A, the uniformity of Thrips population on the plants was confirmed, such that all the tested plants on day 0 had about the same number of Thrips larva per leaf. Table 4B shows the efficacy of the treatments in reducing the number of Thrips larva on cauliflower leaves. As shown in Tables 4A and 4B, treatment of infested cauliflower plants with PPT and neem oil greatly reduced the number of Thrips larva on the leaves compared to UTC. In addition, the combination of PPT with neem oil was slightly more effective in reducing Thrips larva on the leaves compared to neem oil treatment alone. Moreover, the addition of PPT to the treatment comprising acetamiprid and neem oil significantly improved the efficacy of the treatment in reducing Thrips larva on cauliflower leaves. PPT in combination with spirotetramat and neem oil significantly reduced the number of Thrips larva in the leaves compared to the same treatment without PPT. Overall, all treatments with the presence of PPT reduced the damage on leaves caused by Thrips compared to all other treatments in the absence of PPT.

TABLE 4A
Number of Thrips tabaci larva on cauliflower
leaves and level of scraping of the leaves blade.

| | | | Thrips- |
|---|---|---|---|
| | Thrips larva per | | induced |
| | leaf | | damage(0-5) |
| Treatment | 7 DPA | 14 DPA | 14 DPA |
| UTC | 41.4 | 49.4 | 3.0 |
| Neem oil 1% | 35.1 | 41.5 | 2.4 |
| PPT 225 g/ha + neem oil 1% | 24.1^{a} | 31.6^{a} | 1.1^{a} |
| Acetamiprid 60 g/ha + neem oil 1% | 19.6^{a, b} | 31.9^{a} | 2.4 |
| PPT 225 g/ha + acetamiprid 60 g/ha | 17.1^{a, b} | 18.5^{a,b,c} | 0.5^{a,b,c} |
| + neem oil 1% | | | |
| Spirotetramat 50 g/ha + neem oil 1% | 23.3^{a} | 27.1^{a,b} | 1.4^{a} |
| PPT 225 g/ha + spirotetramat 50 | 17.8^{a, b} | 14.6^{a,b,d} | 0.5^{a,b,d} |
| g/ha + neem oil 1% | | | |

^{a}p < 0.05 compared to UTC of the same day.
^{b}p < 0.05 compared to neem oil treatment alone of the same day.
^{c}p < 0.05 compared to acetamiprid + neem oil treatment of the same day.
^{d}p < 0.05 compared to spirotetramat + neem oil treatment of the same day.

TABLE 4B
% efficacy on Thrips larva in cauliflower leaves.

| | % Efficacy | |
|---|---|---|
| Treatment | 7 DPA | 14 DPA |
| UTC | 0 | 0 |
| Neem oil 1% | 15 | 16 |
| PPT 225 g/ha + neem oil 1% | 42 | 36 |
| Acetamiprid 60 g/ha + neem oil 1% | 53 | 36 |
| PPT 225 g/ha + acetamiprid 60 g/ha + neem oil 1% | 59 | 69 |
| Spirotetramat 50 g/ha + neem oil 1% | 44 | 45 |
| PPT 225 g/ha + spirotetramat 50 g/ha + neem oil 1% | 57 | 70 |

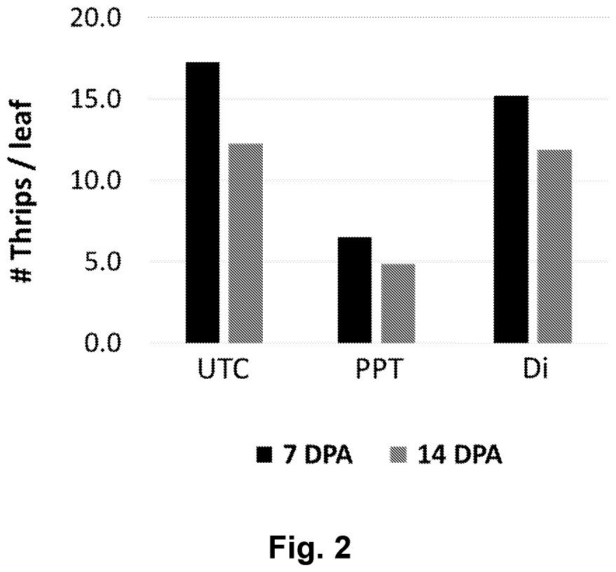

In another experiment, the efficacy of PPT in reducing Thrips infestation in cauliflower plants was assessed compared to a known treatment with diafenthiuron. As shown in Tables 4C and 4D, as well in FIG. 2, PPT at 400 g/ha was markedly more effective than diafenthiuron at 375 g/ha in reducing the number of both Thrips larva and adults on cauliflower leaves.

TABLE 4C
Number of Thrips tabaci adults and larva on cauliflower leaves.

| | Thrips adults per leaf | | | Thrips larva per leaf | | |
|---|---|---|---|---|---|---|
| Treatment | Day 0 | 7 DPA | 14 DPA | Day 0 | 7 DPA | 14 DPA |
| UTC | 3 | 1.8 | 1.4 | 15 | 15.5 | 10.9 |
| Diafenthiuron | 2.9 | 1.3 | 2.1 | 13.0 | 13.9 | 9.8 |
| 375 g/ha | | | | | | |
| PPT 400 g/ha | 3.0 | 0.6 | 0.48^{a,b} | 16.5 | 5.9 | 4.4^{a,b} |

^{a}p<0.05 compared to UTC of the same day.
^{b}p<0.05 compared to diafenthiuron treatment of the same day.

TABLE 4D
% efficacy on Thrips larva in cauliflower leaves.

% Efficacy

| Treatment | 7 DPA | 14 DPA |
|---|---|---|
| UTC | 0 | 0 |
| Diafenthiuron 375 g/ha | 10 | 0 |
| PPT 400 g/ha | 60 | 60 |

### Example 4

PPT is Effective in Reducing Infestation of Resistant Bemisia tabaci (Silverleaf Whiltefly, SLW) Biotype in Cotton Plants

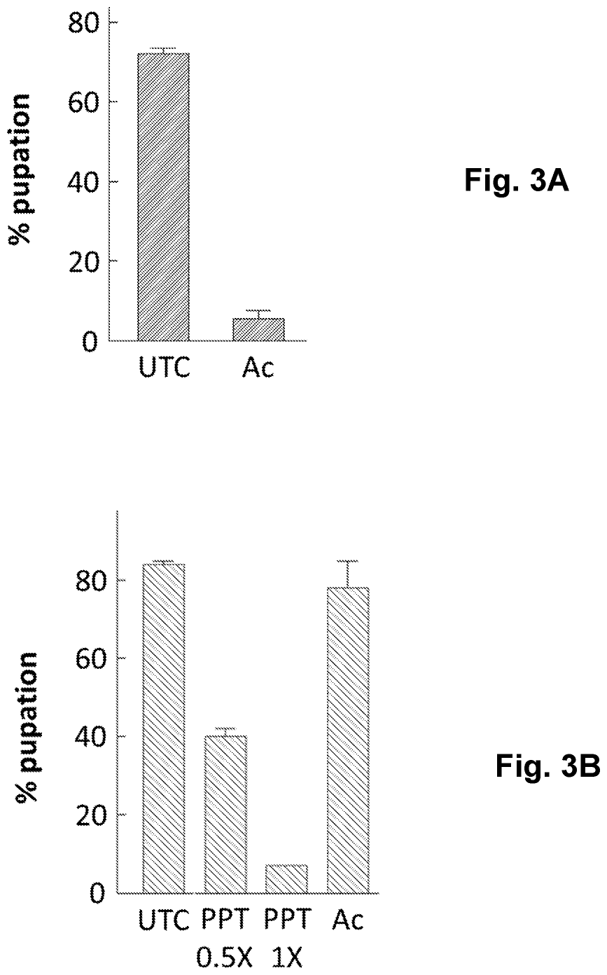

FIG. 3A shows the effect of acetamiprid (a member of the neonicotinoid family) on nymph mortality of SLW biotype B (neonicotinoid-sensitive strain) in cotton plants, as determined by percent of pupation on the leaves. As expected, acetamiprid treatment of infested cotton leaves was efficient in eliminating SLW nymphs of the sensitive strain (biotype B). By contrast, FIG. 3B shows that an identical acetamiprid treatment had no effect on SLW nymphs of the resistant strain (biotype Q). Nonetheless, PPT markedly increased mortality in a dose-dependent manner (up to 93% mortality) of the resistant SLW biotype nymphs.

### Example 5

PPT Reduces Thrips tabaci and Aphis gossypii Infestations in Cotton Plants and Increases Cotton Plants Vigor

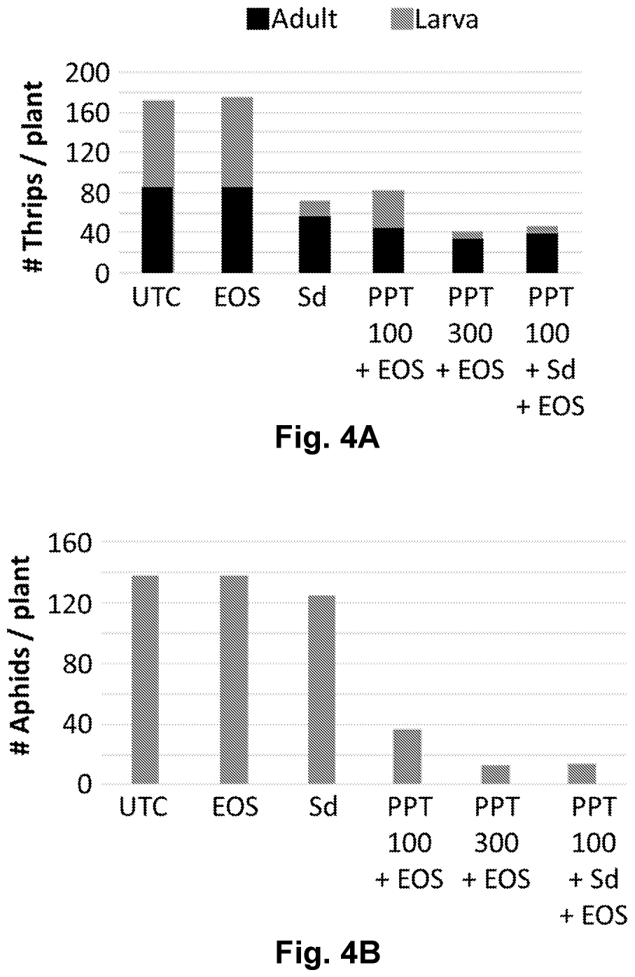

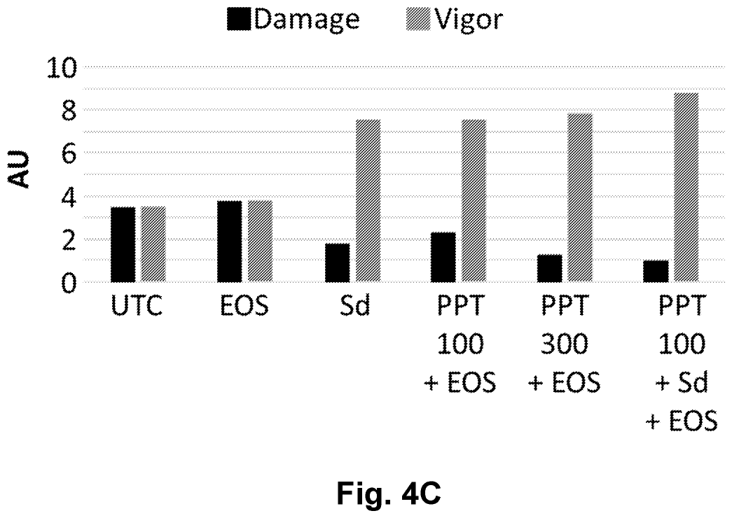

The number of Thrips larva and adults as well as of Aphids (Aphis gossypii) on cotton leaves was counted 6 days after the third application (6DPA3) of the indicated treatments. As shown in FIG. 4A, while mineral oil (EOS) had no effect on the number of Thrips adults and larva, the combination of EOS with PPT significantly reduced the number of Thrips adults on cotton leaves, and also greatly reduced the number of Thrips larva on the leaves in a dose-dependent manner. In addition, the combination of PPT, EOS and spinosad further reduced the number of Thrips adults and larva as compared to spinosad alone.

Moreover, while EOS and spinosad alone had little or no effect on the number of Aphids on the cotton plants, the combination of PPT and EOS with or without spinosad greatly reduced the number of Aphids on the cotton plant (FIG. 4B).

As shown in FIG. 4C, treatment of cotton plants with PPT in combination with EOS reduced the damage to the plant as assessed on a scale of 0-5. Similarly, the combination of PPT, EOS and spinosad was most effective in reducing damage to the plant caused by Thrips and Aphids infestations. These results inversely correspond to the assessment of plant's vigor on a scale of 0-10, where plants treated with a combination of PPT, EOS and spinosad were most vital compared to untreated controls or plants treated with either EOS alone or spinosad alone.

### Example 6

PPT Abrogates Development of Pink Bollworm (Pectinophora gossypiella) Larva

Eggs of pink bollworm were soaked with a 0.15% PPT solution and hatching and larva development was observed compared to untreated controls (UTC). Table 5 shows the average number of eggs at day 0, number of hatchings at day 9 after treatment, and number of late hatchings or larva at day 16 post treatment, calculated from 5 repeats. As shown in Table 5, treatment of pink bollworm eggs with PPT prevented almost entirely hatching of the eggs on day 9. Moreover, although a very small number of late hatchings was observed on day 16 due to the treatment with PPT (no late hatching is expected without treatment), eventually, no larva was observed at the end of the experiment. Therefore, PPT completely abrogated development of pink bollworm larva.

TABLE 5
Average number of eggs, hatchings, late hatchings
and larva of pink bollworm from 5 repeats.

| Treatment | Eggs | Hatchings | Late hatchings | larva |
|---|---|---|---|---|
| UTC | 24.2 | 18 | Not relevant | 11.4 |
| PPT 0.15% | 23.4 | 0.2 | 1.8 | 0 |

### Example 7

PPT Exerts Insecticidal Activity Against Spodoptera littoralis Larva

PPT (at 50 ppm) was lethal to Spodoptera littoralis stage 2-3 larva grown in entomology trays on artificial media. Screening was repeated 3 times, with 4 larva replicates in each screen.

1. A composition comprising at least one protopanaxatriol (PPT)-type compound, which is an insecticide composition, for treating, controlling and/or preventing insect infestation on plants.

2. The composition according to claim 1, wherein the PPT-type compound is selected from PPT-, Rg1-, Rg2-, Re-, Rf-, Rh1- and F1-ginsenoside or any derivative or configuration or modification thereof.

3. The composition according to claim 2, wherein the PPT-type compound is PPT.

4. The composition according to claim 1, wherein the insect is a sucking insect or a chewing insect.

5. The composition according to claim 1, wherein the insect is resistant to one or more insecticides.

6. The composition according to claim 1, wherein the at least one PPT-type compound is applied in combination with one or more additional active ingredient and/or an adjuvant, carrier or diluent.

7. The composition according to claim 6, wherein the additional active ingredient is selected from an insecticide, a neonicotinoid compound, vegetable oil, mineral oil, a terpene, spirotetramat, spinetoram, spionosad, anthranilic diamide, keto-enol, benzoylurea, an insect growth regulator (IGR), pyriproxyfen, pyrrol and diafenthiuron, or any combination thereof.

8. The composition according to claim 7, wherein the neonicotinoid compound is acetamiprid and the vegetable oil is neem oil.

9. The composition according to claim 6, wherein the protopanaxatriol (PPT)-type compound and the additional active ingredient are applied separately, simultaneously or sequentially.

10. The composition according to claim 1, wherein the PPT-type compound is applied at an amount of from 1 g to 1 kg per hectare, from 50 g to 600 g per hectare, from 200 g to 500 g per hectare, or 100 g per hectare.

11. A composition comprising protopanaxatriol (PPT)-type compound for use as an insecticide, in the treatment, control and/or prevention of insect infestation on plants.

12. A method of preparation of an insecticide or an insect control agent comprising the composition as defined in claim 11.

13. The method of claim 12, further comprising one or more additional active ingredients.

14. A method for treating, controlling and/or preventing insect infestation on a plant comprising applying at least one protopanaxatriol (PPT)-type compound, or a composition comprising thereof, onto a plant or a part of a plant.

15. The method according to claim 14, wherein the PPT-type compound or a composition comprising thereof is applied to the plant by spraying, dipping, watering, drenching, irrigating, evaporating, dusting, fogging, foaming, spreading-on, or injecting.

16. The method according to claim 14, wherein the PPT-type compound or a composition comprising thereof is applied to the plant by foliar application.

17. The method according to claim 14, wherein the at least one PPT-type compound is applied in combination with one or more additional active ingredient and/or an adjuvant, carrier or diluent.

18. The method according to claim 17, wherein the protopanaxatriol (PPT)-type compound and the additional active ingredient are applied separately, simultaneously or sequentially.

19. The method according to claim 14, wherein the PPT-type compound is applied at an amount of from 1 g to 1 kg per hectare, from 50 g to 600 g per hectare, from 200 g to 500 g per hectare, or 100 g per hectare.
